(19) United States
(12) Patent Application Publication
(10) Pub. No.: US 2026/0131847 A1
(43) Pub. Date: May 14, 2026

(54) Method and apparatus for operating a steer-by-wire steering system for a motor vehicle, subassembly and motor vehicle

(71) Applicant: Ford Global Technologies, LLC, Dearborn, MI (US)

(72) Inventors: Sergio Codonesu, Aachen (DE); Oliver Nehls, Düsseldorf (DE); Alexander Ein Waldt, Köln (DE); Brian Christopher Branham, Grass Lake, MI (US)

(21) Appl. No.: 19/381,530

(22) Filed: Nov. 6, 2025

(30) Foreign Application Priority Data
Nov. 8, 2024 (DE) 102024132704.9

(51) Int. Cl. B62D 5/00; B62D 6/00; B62D 15/02

(52) U.S. Cl. CPC B62D 5/006; B62D 6/008; B62D 15/0215

(57) ABSTRACT

The disclosure relates generally to a method for operating a steer-by-wire steering system for a motor vehicle in accordance with a calibration mode, to a subassembly, and to a motor vehicle. An example method for operating a steer-by-wire steering system for a motor vehicle in accordance with a calibration mode includes applying an actuating signal to a steering wheel actuator to rotate a steering wheel at a predetermined constant speed, capturing an angle of rotation of the steering wheel during the rotation of the steering wheel at the predetermined constant speed, and determining a rotation-angle-dependent motor torque of an electric motor of the steering wheel actuator that produced the rotation of the steering wheel at the predetermined constant speed.

### RELATED APPLICATION

This patent claims the benefit of German Patent Application No. 102024132704.9, which was filed on November 8, 2024. German Patent Application No. 102024132704.9 is hereby incorporated herein by reference in its entirety. Priority to German Patent Application No. 102024132704.9 is hereby claimed.

### FIELD OF DISCLOSURE

The disclosure relates generally to a method and apparatus for operating a steer-by-wire steering system for a motor vehicle.

### BACKGROUND

Steer-by-wire steering systems (hereinafter, SBW steering systems) are a steering technology in which the direct mechanical connection between the steering wheel and the vehicle wheel is dispensed with and is replaced by two actuators: a steering-wheel actuator with feedback, which generates a feedback torque on the steering wheel for the driver, and a road-wheel actuator which controls at least one steerable vehicle wheel, but typically several steerable vehicle wheels, into the desired position.

### BRIEF DESCRIPTION OF THE DRAWINGS

The disclosure, as well as further advantageous embodiments and developments of the same, will be described and elucidated in more detail in the following with reference to the examples represented in the drawings, in which:

FIG. 1 shows a schematic representation of a motor vehicle with a subassembly according to one embodiment.

FIG. 2A and FIG. 2B show schematic representations of a steering wheel and of a rotation-angle-dependent progression of the internal steering system torque according to the prior art.

FIG. 3 is a flowchart representative of example machine readable instructions and/or example operations that may be executed, instantiated, and/or performed by example programmable circuitry to implement a control device of the subassembly of FIG. 1.

FIG. 4 shows a schematic representation of a method and/or operations performed by the control device of the subassembly of FIG. 1 for the normal operating mode according to a further embodiment.

FIG. 5 is a block diagram of an example processing platform including programmable circuitry structured to execute, instantiate, and/or perform the example machine readable instructions and/or perform the example operations of FIGS. 2 and/or 3 to implement the control device of the subassembly of FIG. 1.

The detailed description below, in conjunction with the appended drawings in which identical numerals refer to identical elements, is intended as a description of various embodiments of the disclosed subject matter and is not supposed to represent the only embodiments. Each embodiment described in this disclosure serves merely as an example or illustration, and should not be construed as being preferred or advantageous in comparison with other embodiments. The illustrative examples contained herein make no claim to completeness and do not limit the claimed subject matter to the exact disclosed forms. Various modifications of the described embodiments are readily discernible for a person skilled in the art, and the general principles defined herein can be applied to other embodiments and applications without deviating from the spirit and scope of the described embodiments. Therefore, the described embodiments are not limited to the embodiments shown, but have the widest possible range of application that is compatible with the principles and features disclosed herein.

All the features disclosed below with respect to the exemplary embodiments and/or the accompanying figures may be combined, on their own or in any subcombination, with features of the aspects of the disclosure, inclusive of features of preferred embodiments.

### SUMMARY

An example method for operating a steer-by-wire steering system for a motor vehicle in accordance with a calibration mode includes applying an actuating signal to a steering wheel actuator to rotate a steering wheel at a predetermined constant speed. The method also includes capturing an angle of rotation of the steering wheel during the rotation of the steering wheel at the predetermined constant speed. The method also includes determining a rotation-angle-dependent motor torque of an electric motor of the steering wheel actuator that produced the rotation of the steering wheel at the predetermined constant speed.

An example subassembly for a vehicle includes a steering wheel, a steering wheel actuator coupled with the steering wheel, the steering wheel actuator including a motor, a steering wheel sensor coupled with the steering wheel, a control device coupled with the steering wheel actuator and with the steering wheel sensor. The control device is to apply an actuating signal to the steering wheel actuator to rotate the steering wheel at a predetermined constant speed; identify an angle of rotation of the steering wheel during the rotation of the steering wheel at the predetermined constant speed; and determine a rotation-angle-dependent motor torque of the motor that produced the rotation of the steering wheel at the predetermined constant speed.

An example vehicle includes a steering wheel, a steering wheel actuator coupled with the steering wheel, the steering wheel actuator including a motor, a steering wheel sensor coupled with the steering wheel, and a control device coupled with the steering wheel actuator and with the steering wheel sensor. The control device is to apply an actuating signal to a steering wheel actuator to rotate a steering wheel at a predetermined constant speed; identify an angle of rotation of the steering wheel during the rotation of the steering wheel at the predetermined constant speed; and determine a torque of the motor that produced the rotation of the steering wheel at the predetermined constant speed, wherein the torque of the motor varies based on the angle of rotation.

### DETAILED DESCRIPTION

In the course of the lateral guidance of a vehicle, the torque feedback on the steering wheel for the driver is important, in order that they put appropriate steering inputs into effect. However, the center of mass of a steering wheel does not normally coincide with the axis of rotation of the steering wheel. The axis of rotation is defined by the extension axis of the steering column to which the steering wheel is coupled. This results in an internal force, based on the distribution of mass of the steering wheel, which introduces an unwanted torque on the steering wheel. The amplitude of this internal steering system torque is not constant, but rather varies as a function of the steering-wheel angle.

An additional variation arises by virtue of the fact that the actual distribution of mass, and therefore also the variation in torque, depends on the shape, design and materials of the steering wheel. For example, a traditional round steering wheel has a different distribution of mass than a yoke-shaped steering wheel. The number of spokes and the size thereof also have an influence on the distribution of mass.

Even within an individual vehicle model, there are differences in the distribution of mass, for example by virtue of differing equipment lines with differing switch configurations, such as rocker switches for example, with differing airbag design, or with alterations that have been brought about by the target market.

In addition to this, torque may also arise from other influences, for example fluctuations in friction in the handwheel actuation unit, that is to say, in the bearings or in an appropriate gear mechanism. The fluctuations in friction may, in addition, fluctuate over the service life of the steering-wheel unit, or may be due to other influences, such as uneven loadings by the user of the vehicle, manufacturing tolerances, or may be due to differing coefficients of expansion, which become noticeable in the event of fluctuations in temperature. As a consequence, the exact distribution of mass generally varies from piece to piece and over the service life, even for each individual steering wheel.

Known steering systems, methods, and subassemblies do not relate to internal influences which arise, for example, by reason of an unequal distribution of mass, by reason of changing friction torques, or by reason of divergent coefficients of expansion. As a consequence, the precision in the course of the torque feedback on the steering wheel for the driver, and therefore the comfort for the driver, is reduced.

There is therefore a need to eliminate or at least to lessen the disadvantages of known methods and subassemblies for operating an SBW steering system. In particular, there is a need to reduce the effort for the calibration of the vehicle for a steering wheel of an SBW steering system of the motor vehicle in comparison with previous approaches, and to be able to make the torque feedback more precise.

The object is achieved by virtue of the subjects of the independent claims. Advantageous configurations are specified in the dependent claims and in the following description, each of which may present aspects of the disclosure, by themselves or in (sub)combination. Some features will be elucidated with regard to methods; others with regard to subassemblies. But the corresponding aspects can be carried across reciprocally in a corresponding manner.

According to one aspect, some embodiments of the disclosure relate to a method for operating an SBW steering system for a motor vehicle in accordance with a calibration mode. The SBW steering system comprises at least one steering wheel, a steering-wheel actuator coupled with the steering wheel, a steering-wheel sensor coupled with the steering wheel, and a control device coupled with the steering-wheel actuator and with the steering-wheel sensor. The method for the SBW steering system operated in the calibration mode comprises at least the following steps:

the steering-wheel actuator has an actuating signal applied to it by the control device, or such a rotation of the steering wheel is exploited, in such a manner that the steering wheel is rotated at a predetermined constant speed by the steering-wheel actuator,

an angle of rotation of the steering wheel is captured by the steering-wheel sensor during the rotation of the steering wheel at the predetermined constant speed,

and a motor torque of an electric motor of the steering-wheel actuator is determined (e.g., estimated, ascertained, etc.) by the control device during the rotation of the steering wheel at the predetermined constant speed, depending on the captured angle of rotation.

The method is based on the insight that a calibration mode can be utilized in order to execute a predetermined and specified rotational motion as regards the steering wheel. This rotational motion can then be utilized in order to capture the motor torque applied in accordance with the predetermined rotational motion. The motor torque with regard to an adjustment motion of the steering wheel is accordingly captured. This subsequently permits internal steering system torques within the system to be ascertained which are caused, for example, by uneven distributions of mass and varying friction torques, as a result of which a calibration of the motion of the steering wheel is made possible. As a result, the fault conditions for the driver are eliminated. As a consequence, motor vehicles that are the same model, or motor vehicles viewed over their service life, and/or even motor vehicles that are different models, can be adapted uniformly as regards the steering feel, so that the respective steering wheels now behave symmetrically and consistently.

In addition, the ascertainment and consideration of the internal steering system torques within the system enables the robustness of the hands-on detection to be distinctly enhanced, enabling a reduction in detection of erroneous operating states and erroneous activations and/or deactivations of driving-assistance and/or driving-automation functions.

A further advantage of the outlined method is that it can be executed for any SBW steering system, regardless of type. In this way, piece-to-piece divergences which, for example, are due to manufacturing tolerances are compensated. Moreover, the method can be carried out repeatedly during the service life of the SBW steering system, so that an invariable steering-wheel calibration for the driver is ensured.

According to a further aspect, some embodiments of the disclosure relate to a subassembly for operating an SBW steering system for a motor vehicle in accordance with a calibration mode. The SBW steering system comprises at least one steering wheel, a steering-wheel actuator coupled with the steering wheel, a steering-wheel sensor coupled with the steering wheel, and a control device coupled with the steering-wheel actuator and with the steering-wheel sensor. The control device for the SBW steering system operated in the calibration mode has been configured:

to apply an actuating signal to the steering-wheel actuator, or to exploit such a rotation of the steering wheel, in such a manner that the steering wheel is rotated at a predetermined constant speed by the steering-wheel actuator.

The steering-wheel sensor has been configured to capture an angle of rotation of the steering wheel during the rotation of the steering wheel at the predetermined constant speed.

The control device has further been configured to estimate or to ascertain a motor torque of an electric motor of the steering-wheel actuator during the rotation of the steering wheel at the predetermined constant speed, depending on the captured angle of rotation.

The advantages that are obtained by the method described herein are also achieved in a corresponding manner by the subassembly.

The SBW steering system of the motor vehicle is to be understood here to mean the conventional SBW steering system of the motor vehicle, but not an auxiliary steering system which is only made possible by torque control as regards drive units and/or retardation devices which have been assigned to respective vehicle wheels, that is to say not a TLC (so-called tertiary lateral control). In this context, the drive units are to be understood to mean appropriately operated electric motors which have been respectively assigned to at least one vehicle wheel and which serve for the propulsion of the motor vehicle but not (primarily) for the lateral guidance of the vehicle. Rather, the drive units are separate from the road-wheel actuators and the electric motors thereof.

The SBW steering system comprises at least one road-wheel actuator which is coupled with at least one steerable vehicle wheel. Optionally, the road-wheel actuator may also have been coupled simultaneously, at least indirectly, with several steerable vehicle wheels, for example via a rack.

Alternatively or additionally, the motor vehicle may comprise several road-wheel actuators, which are respectively coupled individually with several steerable vehicle wheels. As a result, the variability of the SBW steering system is enhanced.

According to another alternative, the motor vehicle may also comprise separate individual road-wheel actuators for at least some steerable vehicle wheels of the motor vehicle. As a result, the corresponding steerable vehicle wheels can be controlled independently of other steerable vehicle wheels for the lateral guidance of the motor vehicle in accordance with wheel-specific orientations. This makes it possible, for example, for individual steerable vehicle wheels to have differing orientations, for example a toe-in position or a toe-out position as regards a tracking position which is defined by the steering specification of the driver.

Optionally, the lateral guidance of the motor vehicle may be based on steering specifications of the driver which they put into effect, for example with the aid of the steering wheel, in order to steer the motor vehicle in a specific direction.

Alternatively or additionally, the lateral guidance of the motor vehicle may, of course, also be based on the route-following functionality of a higher-level driving-control device. The route-following functionality controls the lateral guidance of the motor vehicle in a semiautonomous or autonomous manner, the guidance of the motor vehicle being performed in such a manner that a destination predefined by the driver, or ascertained by the vehicle itself, is reached. The route-following functionality typically makes use of environment data, position data, and/or vehicle data, which are captured with the aid of environment sensors and/or with the aid of a velocity sensor and/or change-of-velocity sensor of the motor vehicle, or which are ascertained by means of a position-signal receiver. Accordingly, the route-following functionality can steer the motor vehicle, for example in accordance with the contour of the road, and adapt the lateral guidance of the motor vehicle for this purpose. On the basis of the route-following functionality, a target angle therefore arises as steering specification for each control interval, in accordance with which the steering wheel and/or the vehicle wheels of the motor vehicle is/are to be controlled in order that the motor vehicle follows the intended trajectory of travel ascertained by the route-following functionality.

The calibration mode is to be distinguished from a normal operating mode of the SBW steering system. This means that the calibration mode has been specifically provided to determine (e.g., estimate, ascertain, etc.) the motor torque of the electric motor of the steering-wheel actuator as a function of a dedicated predetermined rotation of the steering wheel.

The steering-wheel actuator has been configured to apply a torque to the steering wheel at least indirectly, for example via a steering column coupled with the steering wheel. The torque brought about by the steering-wheel actuator is utilized in the normal operating mode of the SBW steering system in order to give the driver torque feedback concerning the lateral guidance of the vehicle.

In general, the steering-wheel actuator comprises an electric motor, in order to be able to apply the torque to the steering wheel. The electric motor may, for example, comprise a set of windings with three windings (e.g., a three-phase set of windings). Alternatively, the electric motor may also comprise more sets of windings.

The steering-wheel sensor has been configured to capture a steering-wheel angle. Alternatively or additionally, the steering-wheel sensor may likewise have been configured to capture a velocity of the steering wheel during the rotation. The steering-wheel sensor communicates the captured measurement data to the control device.

The predetermined constant speed here means that the steering wheel is rotated about the axis of rotation in accordance with a predetermined motion, specifically in accordance with a predetermined velocity. The specification of the value of the constant speed is accomplished by the control device. In an alternative example, the rotation of the steering wheel at the constant speed may also not be based directly on an actuating signal of the control device. Rather, the rotation at constant speed may be based on an intrinsic functionality of the steering wheel, the SBW steering system, and/or the steering-wheel actuator. For example, it may be a question of the resetting (reverse rotation after previous deflection) to a reference position. In this regard, the fact can be exploited that the steering wheel rotates in accordance with such a steering-wheel rotation that the steering wheel is rotated at a predetermined constant speed by the steering-wheel actuator. The steering-wheel sensor enables the check as to whether the actual speed corresponds to the predetermined constant speed.

The actuating signal can, for example, be output from the control device to the steering-wheel actuator. For example, the control device can perform the calibration mode of the SBW steering system.

In an alternative, the output of the actuating signal to the steering-wheel actuator may also occur during the operation of another function, to the extent that this function specifies a constant velocity of the steering wheel, for example by means of a divergent function-control device of the vehicle. Typical examples are entry events and exit events (entry phase or exit phase) of vehicle users, in the course of which entry assistance and exit assistance are ensured with the aid of a rotation of the steering wheel. In these cases, after deflection of the steering wheel by the user of the vehicle, the steering wheel can, after being released, rotate back to the zero position at constant velocity. Therefore, these events can likewise be utilized within the scope of the outlined method, since it is decisive that the steering wheel rotates at constant velocity.

Optionally, the control device may comprise a control loop, for example a control loop with feedback coupling, in order to keep the speed of the steering wheel actually constant in the course of the rotation in accordance with the respective predetermined constant rotation value. Within the control loop of the control device, the angles of rotation captured by the steering-wheel sensor can be taken into account, in order to ascertain the actual speed with the aid of the captured angles of rotation. The actuating signal that was output to the steering-wheel actuator can subsequently be adapted, such that the actual speed corresponds to the predetermined constant value. By virtue of the adaptation of the actuating signal that was output to the steering-wheel actuator, the motor torque brought about by the electric motor of the steering-wheel actuator fluctuates. Within the scope of the ascertainment or estimation of the motor torque, these fluctuations are utilized in order to estimate or to ascertain the motor torque, depending on the angle of rotation. Expressed otherwise, in this way, the fluctuations that are comprised by the motor torque brought about by the electric motor of the steering-wheel actuator can be ascertained as a function of the specific orientation of the steering wheel as regards a reference position, for example a zero position. This enables the ascertainment of rotation-angle-dependent internal steering system torques within the system.

This means that averaging is not carried out over the entire rotational motion executed by the steering wheel in the course of the ascertainment or estimation of the motor torque of the electric motor of the steering-wheel actuator. Rather, the rotational motion is subdivided into control intervals in accordance with the control period of the control device and/or in accordance with the time constants of the steering-wheel sensor. In this way, the motor torque of the electric motor of the steering-wheel actuator during the rotational motion of the steering wheel can be ascertained or estimated with high angular resolution and with high precision.

In some embodiments, a predefined routine based on the actuating signal is taken into account in the course of the rotating of the steering wheel at the predetermined constant speed. The routine here means that the steering wheel executes a predetermined sequence of motions. For example, the actuating signal may be such that the steering wheel first executes a clockwise rotation at the predetermined constant speed for a first set-angle interval. Directly subsequent to this, a further motion of the steering wheel counterclockwise can be put into effect for a second set-angle interval. Directly subsequent to this, in turn, a motion of the steering wheel in accordance with a third set-angle interval can be put into effect, once again clockwise. Eventually, after at least two partial motions corresponding to various set-angle intervals, the steering wheel can be moved back to the initial position, for example a zero position corresponding to a straight-ahead position. The routine can generally be specified variably by the control device. Of course, the routine may also comprise individual motions corresponding to an individual set-angle interval or alternatively several, in particular more than two or three, partial motions corresponding to differing set-angle intervals.

Optionally, the rotational velocity can also be varied during a rotation of the steering wheel. However, this represents a greater evaluation effort, for which reason a constant rotational velocity corresponding to a constant speed is preferred.

Optionally, in the course of the ascertainment of the motor torque, a captured torque in a steering column, in particular a torsion-bar torque in the steering column, is taken into account by the control device. The steering wheel is coupled with the steering column. The torque (torsion-bar torque) in the steering column can be captured, for example via a torque sensor which may take the form of a torsion sensor (sometimes also designated as a steering-torque sensor). Since the steering column corresponds to the axis of rotation, the motor torque that is applied by the electric motor of the steering-wheel actuator can be estimated or ascertained by means of the captured torque (torsion-bar torque).

Alternatively or additionally, in the course of the estimating of the motor torque, a captured amplitude of an actuator current consumed by the steering-wheel actuator is taken into account by the control device. A current sensor which is coupled with the control device can be utilized for the purpose of capturing the actuator current. Alternatively or additionally, the voltage amplitude at which the electric motor of the steering-wheel actuator is previously known can also be captured with the aid of a voltage sensor. The control device can then ascertain the electrical power consumption of the electric motor. With the aid of the electrical power consumption, the control device can ascertain the motor torque that is output by the electric motor.

In some embodiments, the steering wheel is repeatedly rotated at identical and/or differing predetermined constant speeds in accordance with differing actuating signals. The angle of rotation during the rotation of the steering wheel is then captured in each instance, and the motor torque of the electric motor is ascertained or estimated in each instance. This means that the calibration motion of the steering wheel can be carried out with differing parameters. As a result, internal steering system torques within the system can likewise be identified that only arise at specific rotational velocities of the steering wheel. Ultimately, an additional degree of freedom is made available for the characterization of the rotation of the steering wheel, as a result of which disturbances within the system can be identified still more precisely. In addition, systematic errors of the calibration mode can also be avoided by this means. Moreover, the repeated rotational motion and evaluation as regards the motor torque of the electric motor of the steering-wheel actuator has the result that the motor torque can be estimated with higher precision. For example, by virtue of the differing speeds, the parameter space is enlarged in the course of the estimation of the motor torque, having a positive effect on differing estimation routines, for example on a linear regression.

The calibration mode of the SBW steering system is preferably implemented during a manufacturing phase, an installation phase, a maintenance phase, a function-test phase, a starting-adjustment phase, an automatic maneuvering phase for pulling into or out of a parking space, an entry phase or exit phase, an absence phase, or a standstill phase of the motor vehicle. The large number of phases already makes it clear that the steering wheel can be characterized repeatedly and in accordance with a great variety of vehicle states. The method is accordingly capable of being carried out at many different times, so that the calibration of the rotational motion of the steering wheel does not depend on an individual particular environment, for example a manufacturing environment. As a result, the variability of the method is enhanced.

In the course of the starting adjustment, generally, a possible angular misalignment between the vehicle wheels and the steering wheel of the SBW steering system is eliminated in the course of, or prior to, the starting of the vehicle.

In the case of automatic maneuvering phases for pulling into or out of a parking space, the motor vehicle is controlled automatically by a driving-control device. The driver typically does not have their hands on the steering wheel. During these two phases, the steering wheel is rotated in a defined manner, for example as a percentage relative to the demanded wheel angles of the parking-assistance system. This automated rotation of the steering wheel can be exploited for the method outlined herein, since the steering wheel can, in particular, be rotated at constant speed.

In the entry phase or exit phase, the driver is potentially supporting themself on the steering wheel and is able to turn it, for example in relation to a reference position. As soon as they release the steering wheel, the steering wheel is rotated back to the reference position, for example a zero position corresponding to a straight-ahead orientation. This motion into the original position can likewise be exploited for the method outlined herein, since, here too, the steering wheel can be rotated at constant speed.

In the phases of the starting adjustment, of the maneuvers for pulling into and out of a parking space, and also during the reverse rotation after entry and exit, the driver usually does not have their hands on the steering wheel. If the driver is nevertheless keeping a firm hold on the steering wheel, within the scope of the method, this can be detected by the control device, since the steering wheel cannot be moved, or can only be moved with (unusually) high motor torques. By virtue of the utilization of the starting adjustment, of the maneuvering phases for pulling into and out of a parking space, and also of the entry or exit phases, the precision in the course of the ascertainment or estimation of the motor torque during the rotation of the steering wheel is more robust, since any internal steering system torques of the driver can be averaged out or eliminated. If hands-on detection based on additional signals, or an additional hands-on sensor, such as capacitive steering-wheel mats for example, has been integrated within the steering wheel, this can be utilized in order to execute the method represented herein only when the driver does not have their hands on the steering wheel. As a result, the precision of the ascertainment or estimation of the motor torque during the rotation of the steering wheel can be increased further.

The absence phase can be captured by the control device, for example via passenger-compartment sensors which communicate the corresponding measurement data to the control device. For example, the absence phase can also be recognized by the control device by virtue of the fact that the motor vehicle is parked and subsequently locked. Moreover, the absence phase can be recognized by virtue of the fact that the user of the vehicle is captured in the vicinity of the motor vehicle with the aid of environment sensors, or by virtue of the fact that an approach of the vehicle key to the motor vehicle is captured. In the absence phase, it is clear that the driver is unable to exert a manual torque on the steering wheel, for which reason the method can proceed without distortion.

Optionally, the calibration mode of the SBW steering system is implemented at predetermined time intervals, at certain traveled distances, in function sequences or, depending on external conditions, repeatedly during corresponding phases of the motor vehicle. For this purpose, the control device may comprise an appropriate routine that identifies a phase in which the method can be carried out in accordance with the calibration mode. Accordingly, the calibration as regards the internal steering system torques within the system can be repeated at regular intervals. The external conditions may, for example, have an influence to the effect that fluctuations in temperature that, for example, are greater than a threshold value of the temperature difference can be used as an opportunity to carry out the method again in accordance with the calibration mode. Otherwise, fluctuations in temperature might result in a significantly altered steering behavior of the steering wheel by virtue of divergent coefficients of expansion.

The control device preferably estimates, on the basis of the ascertained or estimated motor torque of the electric motor, an internal steering system torque acting on the rotation of the steering wheel, depending on the captured angle of rotation. For this purpose, the control device may utilize, for example, lookup tables, approximation methods such as a linear regression, or complex functions such as higher-degree polynomials, for example. In general, the motor torque that the electric motor of the steering-wheel actuator should actually employ for the predetermined rotation of the steering wheel at constant speed is known. The divergence from this set specification makes it possible to ascertain the rotation-angle-dependent internal steering system torques that act on the rotation of the steering wheel. The internal steering system torques ascertained in this way can subsequently be taken into account in the course of the control of the steering-wheel actuator, in order to ensure an invariable uniform steering feel for the driver as regards the steering wheel.

In some embodiments, the control device utilizes a disturbance observer, an estimation algorithm, a Kalman filter or a torque-equilibrium equation for the purpose of estimating the internal steering system torque. As a result, a large number of different estimation algorithms may have been implemented in the control device, in order to estimate the rotation-angle-dependent internal steering system torque. The disturbance observer may, for example, reflect a disturbed system state relative to a set system state, eventually enabling the estimation of the internal steering system torque.

Optionally, the rotation-angle-dependent internal steering system torque is stored in a data memory which is coupled with the control device or is internal thereto. As a result, the information pertaining to the rotation-angle-dependent internal steering system torque is also available for subsequent functionalities of the SBW steering system. In addition, this enables a comparison of the results as regards the rotation-angle-dependent internal steering system torque in the case where the method is repeated at a later time. For example, alterations of the characteristic of the steering-wheel rotation can be identified in this way. These alterations can, for example, be utilized in order to estimate whether structural parts or components of the SBW steering system as regards the steering wheel require maintenance or exchange.

The control device preferably takes the estimated internal steering system torque into account in the course of control for the purpose of torque feedback to the driver during a normal operating mode of the SBW steering system. The control device then compensates for the estimated internal steering system torque with the aid of an ascertained compensation torque. This means that the compensation torque counteracts the estimated internal steering system torque. The torque actually desired for rotating the steering wheel is then summed with the ascertained compensation torque, as a result of which the effects of the rotation-angle-dependent internal steering system torque are balanced out. In this way, an invariable steering feel for the driver is ensured, for which reason comfort is enhanced by the present method.

In addition, the compensation ensures that the calibration of the feedback-coupling controls as regards the torque feedback to the driver have also been simplified, and that, on the basis of the method, all the steering wheels behave symmetrically and consistently relative to one another.

Optionally, the control device corrects an actual motor torque of the electric motor of the steering-wheel actuator with the ascertained compensation torque during the normal operating mode of the SBW steering system, in order to estimate the driver torque applied to the steering wheel by the driver. In this way, the precision in the course of the estimation of the driver torque can be enhanced.

Alternatively or additionally, the control device outputs the ascertained compensation torque for further components of the motor vehicle. In this way, the ascertained compensation torque can, for example, be utilized by a control device that controls the hands-on detection on the basis of the utilization of the steering-wheel torque. The steering-wheel torque either can be measured or can be estimated on the basis of the motor torque. As a consequence, the influences of the internal steering system torques acting on the rotation of the steering wheel in the course of the hands-on detection can be reduced, as a result of which the reliability of the hands-on detection is drastically increased. For example, erroneous capture events can be avoided in this way.

In general, the control device may comprise an algorithm that performs the evaluation functions and control functions as regards the motor torque, the internal steering system torque, the compensation torque and the actual driver torque. The algorithm then has a function for ascertaining or estimating the motor torque, depending on the captured angle of rotation of the steering wheel during the rotation at the predetermined constant speed. Furthermore, the algorithm may likewise have a function that undertakes the estimating of the internal steering system torque, depending on the captured angle of rotation. In addition, the algorithm may comprise a function according to which the internal steering system torque is taken into account in the course of the control of the torque feedback to the driver in the normal operating mode with the aid of the compensation torque. Moreover, the algorithm may comprise a function in which the compensation torque ascertained in this way is utilized in order to estimate the driver torque actually applied by the driver in the normal operating mode. In this case, the actual motor torque is corrected with the compensation torque.

Optionally, the method takes the form of a computer-implemented method. This means that the steps of the method can be executed with the aid of one or more data-processing devices. In particular, a data-processing device of the control device can trigger or execute the corresponding steps.

According to a further aspect, the disclosure also relates to a computer program product comprising instructions that in the course of the execution of the program by a computer induce the latter to execute the method as described herein. The advantages that are obtained by the method described herein are also achieved in a corresponding manner by the computer program product.

According to an additional aspect, the disclosure also relates to a computer-readable storage medium comprising instructions that in the course of the execution of the program by a computer induce the latter to execute the method as described herein. The advantages that are obtained by the method described herein are also achieved in a corresponding manner by the computer-readable storage medium.

According to a further aspect, the disclosure also relates to a motor vehicle with a subassembly as described herein or with a subassembly that is capable of being operated in accordance with a method as described herein.

The advantages that are obtained by the method described herein are also achieved in a corresponding manner by the motor vehicle.

In the sense of the disclosure, motor vehicles may encompass, in particular, land vehicles, namely, amongst other things, all-terrain vehicles and road vehicles such as passenger cars, buses, trucks and other commercial vehicles. Motor vehicles may be manned or unmanned. Motor vehicles may be electrically powered, at least partly, may comprise an internal combustion engine and/or an electric motor serving for propulsion.

All the features elucidated with regard to the various aspects are capable of being combined, individually or in (sub)combination, with other aspects.

For the purposes of the disclosure, the wording "at least one of A, B and C" means, for example, (A), (B), (C), (A and B), (A and C), (B and C) or (A, B and C), inclusive of all the other possible combinations if more than three elements are listed. In other words, the term "at least one of A and B" generally means "A and/or B", namely "A" alone, "B" alone or "A and B".

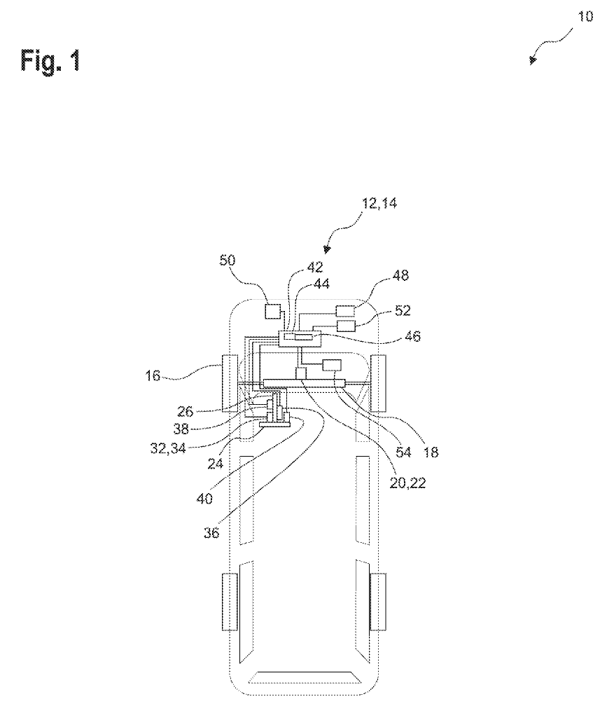

FIG. 1 shows a simplified schematic representation of a motor vehicle 10 with a subassembly 12 according to one embodiment.

The subassembly 12 of the motor vehicle 10 comprises an SBW steering system 14 with steerable vehicle wheels 16. The steerable vehicle wheels 16 are coupled with a common rack 18. The common rack 18 can be moved out of a reference position, for example a zero position, thus bringing about a steering motion of the steerable vehicle wheels 16. In this way, the steerable vehicle wheels 16 can be deflected, for example starting from a straight orientation of the motor vehicle 10, in order that the motor vehicle 10 executes a cornering maneuver.

For the purpose of moving the rack 18, according to this embodiment, the SBW steering system 14 comprises a single road-wheel actuator 20 which here can jointly influence the orientation of both steerable vehicle wheels 16 (e.g., front wheels) of the motor vehicle 10. In the present case, the road-wheel actuator 20 is coupled with the rack 18. Alternatively, the road-wheel actuator 20 may also have been coupled with the steerable vehicle wheels 16 in another way, in order to be able to influence the orientation thereof.

In an alternative, several road-wheel actuators 20 may also have been provided which are respectively coupled individually with a steerable vehicle wheel 16. This has the advantage that the vehicle wheels 16 are not moved jointly, as a result of which the vehicle wheels 16 can be oriented individually. For example, individual vehicle wheels 16 can then take up dedicated off-tracking positions, for example for specific driving situations (off-road driving). Off-tracking position here means that the vehicle wheels 16 are not then oriented in accordance with the set tracking position which is defined by the steering specification of the driver.

The motor vehicle 10, the subassembly 12 and the SBW steering system 14 may of course also comprise further steerable vehicle wheels 16, for example rear wheels, which are coupled with an additional common road-wheel actuator or with individual road-wheel actuators 20, even though these are not represented in the embodiment of FIG. 1.

Each road-wheel actuator 20 comprises an electric motor 22. The electric motor 22 comprises at least one set of windings which comprises a group of windings. Each set of windings has been configured in order that phase currents, which can be utilized for the purpose of driving a rotor of the electric motor 22, arise in the underlying windings when supply signals, such as phase voltages, are applied to them. The rotor may then have been coupled with a corresponding component of the electromechanical steering system 14, for example with the rack 18, and in this way can enable the motion of the steerable vehicle wheels 16.

In general, the electric motor 22 may also comprise more than one set of windings.

Each set of windings is typically three-phase, so that the electric motor 22 has been designed overall to be at least three-phase, optionally also six-phase or nine-phase.

If several sets of windings are present, the sets of windings enable a motion of the rotor of the electric motor 22, each one independently of other sets of windings. This means that the sets of windings are separate from one another.

In general, the subassembly 12 comprises wheel sensors (not shown here), for example speed sensors, with the aid of which the speeds of the vehicle wheels 16 in the circumferential direction (rolling direction) can be captured individually. On the basis of the captured speeds, the wheel-specific slip, for example, can be ascertained.

The SBW steering system 14 of the motor vehicle 10 comprises, in addition, a steering wheel 24. With the aid of the steering wheel 24, a driver of the motor vehicle 10 can put steering specifications for the motor vehicle 10 into effect, in order to steer the motor vehicle 10 in a desired direction.

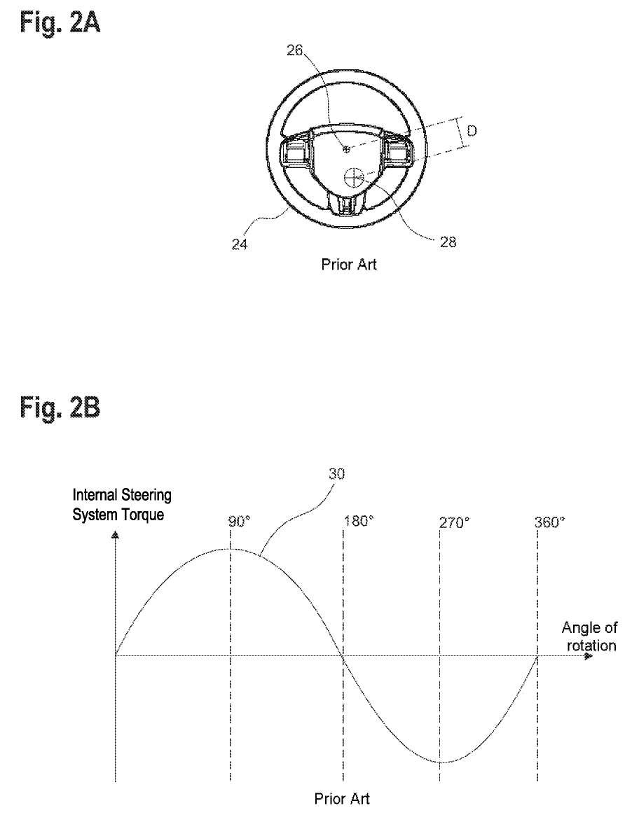

The steering wheel 24 is coupled with a steering column 26 of the SBW steering system 14. The steering column 26 defines the axis of rotation about which the steering wheel 24 is capable of being rotated. However, the center of mass of the steering wheel 24 typically does not coincide with the axis of rotation of the steering column 26. In this context, FIGS. 2A and 2B show simplified schematic representations of a steering wheel 24 and of a rotation-angle-dependent progression of the internal steering system torque according to the prior art.

FIG. 2A shows that the center of mass 28 of the steering wheel 24 has been shifted by a distance D in relation to the axis of rotation of the steering column 26 by reason of the geometry of the steering wheel 24 with an additional spoke. In accordance with a Cartesian coordinate system, the distance D may, of course, comprise both a horizontal partial distance and a vertical partial distance. This results in a disturbing force which exerts an internal steering system torque 30 in the course of the rotation of the steering wheel 24. FIG. 2B shows how the internal steering system torque 30 (y-axis) varies, depending on the angle of rotation (x-axis), there being only a vertical distance of the center of mass from the axis of rotation in this example. It becomes clear here that the internal steering system torque 30 is inconstant, in particular over the angle of rotation. This gives rise to the challenges in the coordination of the rotation of the steering wheel 24. By virtue of piece-to-piece divergences, manufacturing tolerances, differences in friction, and parameters changing during the service life, as well as fluctuations in temperature, the internal steering system torque 30 does not comprise an invariable rotation-angle-dependent progression, even viewed over the service life of an individual steering wheel 24. Rather, the dependence of the internal steering system torque 30 on the angle of rotation varies over the service life of the steering wheel 24.

Returning to the illustrated example of FIG. 1, a steering-wheel actuator 32 of the SBW steering system 14 is coupled with the steering wheel 24. The steering-wheel actuator 32 comprises a further electric motor 34. The electric motor 34 of the steering-wheel actuator 32 likewise comprises at least one set of windings. Each set of windings of the electric motor 34 is three-phase and has been configured to drive a rotor of the electric motor 34. As a consequence, a feedback torque for the driver can be made available on the steering wheel 24 of the motor vehicle 10 by the electric motor 34, in order to convey to the driver a feel concerning the lateral guidance of the motor vehicle 10.

The SBW steering system 14 comprises, in addition, at least one steering-wheel sensor 36 which is coupled with the steering wheel 24. Each steering-wheel sensor 36 has been configured, independently of other steering-wheel sensors 36, to capture a steering specification of the driver in relation to a reference position with the aid of a steering-wheel angle (angle of rotation) and/or a velocity of the steering wheel 24.

The steering-wheel sensor 36 has been represented here as being coupled with the steering column 26, since the steering wheel 24 is rigidly coupled with the steering column 26, and consequently a rotation of the steering wheel 24 translates directly into a rotation of the steering column 26.

In general, the steering-wheel sensor 36 may, of course, also have been coupled with the steering wheel 24 itself, for example with a base component of the steering wheel 24, instead of with the steering column 26. In this case, the steering-wheel sensor 36 can itself capture the rotation of the steering wheel 24 directly.

The electromechanical steering system 14 further comprises, according to this embodiment, a torque sensor 38 (preferably a torsion sensor) which is coupled with the steering column 26. The torque sensor 38 has been configured to capture a torque (torsion-bar torque) introduced into the steering column 26. Portions of the torque (torsion-bar torque) may be based, in particular, on the inequality of mass of the steering wheel 24 in which the center of mass 28 of the steering wheel 24 does not coincide with the axis of rotation of the steering column 26. The torque sensor 38 can capture this torque (torsion-bar torque).

According to this embodiment, the SBW steering system 14 additionally comprises a generally optional hands-on sensor 40 which is coupled with the steering wheel 24. The steering wheel 24 typically comprises for this purpose at least two electrically conductive layers which have electrical supply signals, for example divergent voltages, applied to them. If the driver of the motor vehicle 10 places their hand on the steering wheel, the relative capacitance ratios change, and this can be captured by the hands-on sensor 40. In this way, it can be detected whether a driver of the motor vehicle 10 is keeping a firm hold on the steering wheel 24.

The subassembly 12 further comprises a control device 42 with a data-processing device 44. In general, the control device 42 may also be a control device of the SBW steering system 14. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

By virtue of the data-processing device 44, at least one mass-inequality-distribution and friction-compensation algorithm 46 is implemented.

The control device 42 is at least indirectly coupled with the road-wheel actuator 20, with the steering-wheel actuator 32, with the steering-wheel sensor 36, with the torque sensor 38, and with the hands-on sensor 40.

In addition, according to this embodiment, the subassembly 12 comprises at least one position-signal receiver 48, an environment sensor 50, a storage device 52 and a passenger-compartment sensor 54, all of which are at least indirectly coupled with the control device 42.

By means of the position-signal receiver 48, a position signal of a global navigation satellite system can be received, so that the control device 42 can ascertain the position of the motor vehicle 10 on the basis of the received position signal.

The environment sensor 50 may comprise at least one of a camera, a radar sensor, a lidar sensor and an infrared sensor. The environment sensor 50 communicates the captured environment-sensor data to the control device 42 which can ascertain, on the basis of the received environment-sensor data, whether the motor vehicle 10 is located in a specific environment.

With the aid of the storage device 52, ascertained data, for example an ascertained internal steering system torque 30, can be stored for later applications, or corresponding data can be retrieved from the control device 42, for example for comparison purposes.

With the aid of the passenger-compartment sensor 54, it can be detected whether a driver of the motor vehicle 10 is located in a passenger compartment of the motor vehicle 10.

The position-signal receiver 48, the environment sensor 50, the storage device 52 and the passenger-compartment sensor 54 communicate the corresponding data to the control device 42 automatically or when the control device 42 retrieves the corresponding data.

The control device 42 has been represented here as part of the subassembly 12. In general, the control device 42 can also assume responsibility for further control mechanisms of the SBW steering system 14. For example, the control device 42 may also have been configured to output torque feedback to the driver of the motor vehicle 10 concerning the lateral guidance of the motor vehicle 10 with the aid of the steering wheel 24 and the steering-wheel actuator 32 in the normal operating mode of the SBW steering system 14. For the purpose of ascertaining the feedback torque to be applied by the steering-wheel actuator 32 to the steering column 26 and therefore to the steering wheel 24, captured data of road-wheel sensors (not represented here) which are coupled with the vehicle wheels 16 are then typically utilized by the control device 42.

The SBW steering system 14 may of course also comprise several components of the same type and generally having the same function, for example several steering-wheel sensors 36, as a result of which a redundancy is ensured.

The example control device 42 of FIG. 1, may be implemented by hardware alone or by hardware in combination with software and/or firmware. Thus, for example, the control device 42, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software).

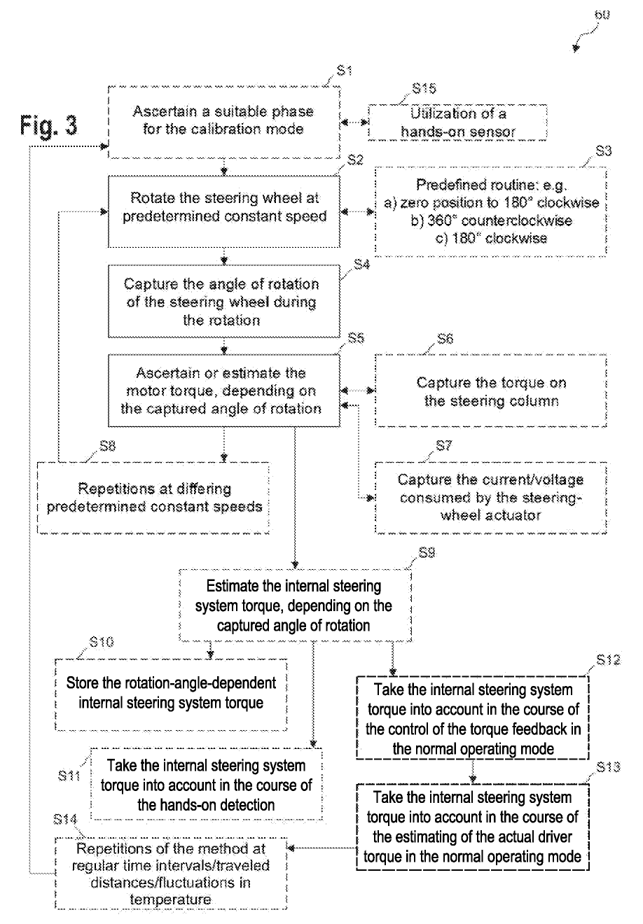

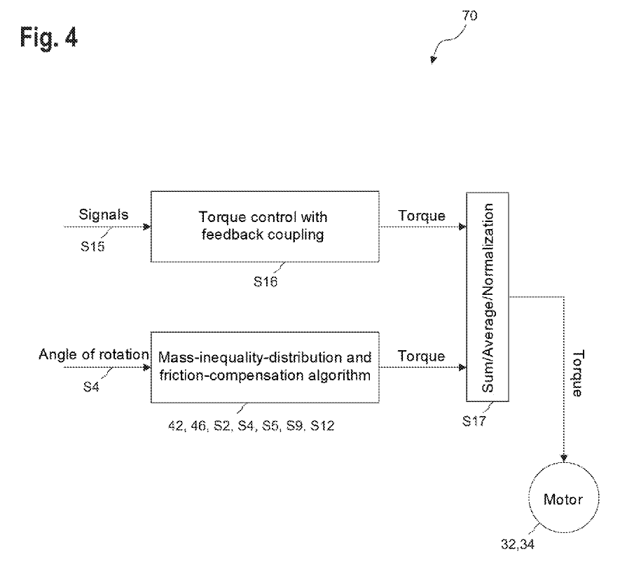

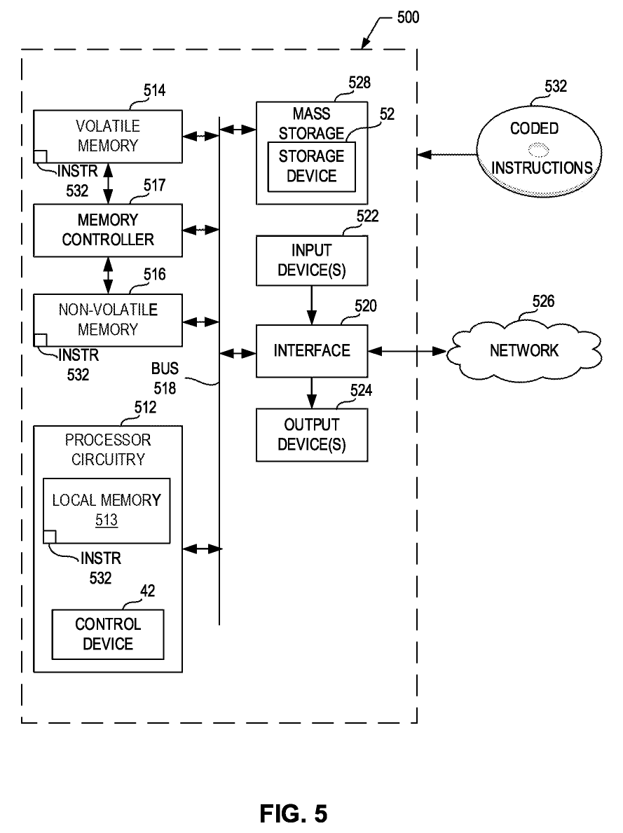

Flowcharts representative of example machine readable instructions, which may be executed by programmable circuitry to implement and/or instantiate the control device 42 of FIG. 1 and/or representative of example operations which may be performed by programmable circuitry to implement and/or instantiate the control device 42 of FIG. 1, are shown in FIGS. 3-4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example control device 42 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 60 that may be executed, instantiated, and/or performed by programmable circuitry to operate the SBW steering system 14 (FIG. 1) according to one embodiment. Optional steps have been represented using broken lines.

In optional step S1, a suitable phase for the calibration mode is ascertained by the control device 42. For this purpose, the control device 42 may utilize, for example, the position-signal receiver 48, the environment sensor 50 and/or the passenger-compartment sensor 54. As a consequence, on the basis of received environment data, a received position signal and/or the captured passenger-compartment data, the control device 42 can ascertain that the motor vehicle 10 is arranged in accordance with one of a manufacturing phase, an installation phase, a maintenance phase, a function-test phase, a starting-adjustment phase, an automatic maneuvering phase for pulling into or out of a parking space, an entry or exit phase, an absence phase or a standstill phase of the motor vehicle. All these phases are suitable in order to execute the calibration mode, elucidated below, for calibrating the steering wheel 24.

Optionally, the method 60 can be extended, by optional step S1 being extended by optional step S15. An optional hands-on sensor 40 or hands-on detection is then utilized for the ascertainment of a suitable phase for the calibration mode. For example, in this way, the control device 42 can establish whether the driver has their hands on the steering wheel 24, as a result of which the method 60 might be distorted.

The method 60 then comprises step S2 in which the steering-wheel actuator 32 has an actuating signal applied to it by the control device 42 in such a manner that the steering wheel 24 is rotated at a predetermined constant speed by the steering-wheel actuator 32. The steering wheel 24 accordingly executes a predefined motion. In an alternative, in step S2, the circumstance can be exploited that a rotation of the steering wheel 24 is brought about in such a manner that the steering wheel 24 is rotated at a predetermined constant speed by the steering-wheel actuator 32, for example within the scope of a return of the steering wheel to a reference position.

Optionally, step S2 can be extended by step S3 in which the control device 42 utilizes a predefined routine in the course of the rotation of the steering wheel 24. An exemplary routine may comprise a first partial rotation clockwise, followed by a second partial rotation counterclockwise, followed in turn by a third partial rotation, again clockwise. As a consequence, the steering wheel 24 can be returned to the initial position after the routine. Of course, the routine may have been designed in many different ways. The essential point is merely that the motion to be executed by the steering wheel 24 has been predefined. The motion of the steering wheel 24 is preferably executed at a predetermined constant speed.

Alternatively, motions of the steering wheel 24 are also conceivable, in the course of which the speed is varied during the rotation. However, the evaluation effort is then increased.

The method 60 now comprises step S4 in which the angle of rotation of the steering wheel 24 during the rotation of the steering wheel 24 at the predetermined constant speed is captured by the steering-wheel sensor 36. The correspondingly captured measurement data are communicated from the steering-wheel sensor 36 to the control device 42.

The method 60 subsequently comprises step S5. The control device 42 determines (e.g., estimates, ascertains, etc.) the motor torque of the electric motor 34 of the steering-wheel actuator 32 during the rotation of the steering wheel 24 at the predetermined constant speed, depending on the captured angle of rotation. This means that the control device 42 does not merely determine an average motor torque of the electric motor 34, but actually determines a rotation-angle-dependent progression of the motor torque of the electric motor 34. By virtue of the internal steering system torque 30 acting on the rotation of the steering wheel 24, the motor torque of the electric motor 34 will generally not have a constant value over the angle of rotation. Rather, the motor torque of the electric motor 34 will vary, depending on the angle of rotation.

For step S5, the control device 42 can take optional step S6 into account, by taking into account the torque (torsion-bar torque) captured as a function of the angle of rotation, which is introduced into the steering column 26 during the rotation of the steering wheel 24. For this purpose, the control device 42 may utilize, in particular, the torque sensor 38 which captures, for example, the torque (torsion-bar torque).

Alternatively or additionally, step S5 can be extended by optional step S7, by the electrical power consumption of the steering-wheel actuator 32 being taken into account by the control device 42 in the course of the estimation of the motor torque of the electric motor 34 of the steering-wheel actuator 32. For this purpose, the SBW steering system 14 may comprise current sensors and/or voltage sensors which capture the supply signals of the steering-wheel actuator 32 as regards the current amplitude and/or voltage amplitude, and communicate corresponding measurement values to the control device 42. Since the geometry of the electric motor 34 of the steering-wheel actuator 32 is fixed, the control device 42 can determine (e.g., estimate, ascertain, etc.) the motor torque that is output by the electric motor 34 by means of the captured electrical parameters.

The method 60 may then feature optional step S8 in which at least steps S2, S4 and S5 are repeated. In the course of the repetitions, motions of the steering wheel 24 are executed on the basis of divergent actuating signals at differing or identical predetermined constant speeds. In this way, a larger database can be created, in order eventually to be able to ascertain the motor torque more precisely than without the repetitions. For example, variations in the motor torque depending on the speed can also be ascertained in this way.

In the following optional step S9, the control device 42 estimates the internal steering system torque 30 acting on the rotation of the steering wheel 24 on the basis of the determined (e.g., ascertained, estimated, etc.) motor torque of the electric motor 34, depending on the captured angle of rotation. For this purpose, the information about the captured angle of rotation from step S4 is again utilized, which in this regard is transmitted from step S4 via step S5 to step S9. The control device 42 makes use, in particular, of the mass-inequality-distribution and friction-compensation algorithm 46. For this purpose, the control device 42 may, for example, exploit a disturbance observer, an estimation algorithm, a Kalman filter or a torque-equilibrium equation in order to estimate the internal steering system torques 30.

In accordance with optional step S10, the control device 42 stores the information about the estimated rotation-angle-dependent internal steering system torque 30 for later use. For example, the internal steering system torque 30 can be stored in the storage device 52.

The method 60 also comprises optional step S11 in which the internal steering system torque 30 estimated in optional step S9 is taken into account in the course of the hands-on detection. Above all, if hands-on detection is based on the determined (e.g., ascertained, estimated, etc.) motor torque of the electric motor of the steering-wheel actuator during the rotation, a distinctly increased precision of the hand-on detection can be obtained by consideration of the internal steering system torque. In this case, a dedicated hands-on sensor 40 can accordingly be dispensed with.

The method then comprises optional step S12 in which the internal steering system torque 30 estimated in step S9 is taken into account by the control device 42 in the course of the control of the torque feedback to the driver in the normal operating mode of the SBW steering system 14. For this purpose, the control device 42 can determine (e.g., ascertain, estimate, etc.) a compensation torque that is opposed to the internal steering system torque 30. The control device 42 can communicate the compensation torque to the steering-wheel actuator 32. The feedback torque applied by the steering-wheel actuator 32 to the steering wheel 24 for the purpose of torque feedback to the driver then has the compensation torque as an additional term, so that the effects of the internal steering system torque 30 have been compensated. As a result, a homogeneous, invariable and uniform characteristic of the steering wheel 24 in the course of the torque feedback is ensured. In this way, it is also ensured that the steering wheel 24, during its service life, and differing steering wheels, for example of the same vehicle type or of differing vehicle types, display a uniform characteristic of the torque feedback.

In the present case, optional step S12 is performed by the control device 42 which in this regard is also utilized in the normal operating mode of the SBW steering system 14. In general, in the normal operating mode of the SBW steering system 14, a different control device may also be utilized which is separate from the control device 42 represented here. In this case, the control device 42 may have been provided, in particular and exclusively, for the calibration mode, represented here, of the SBW steering system 14. However, for the purpose of minimizing effort, the SBW steering system 14 will typically comprise only a single control device 42 which is utilized both in the calibration mode and in the normal operating mode.

According to the following optional step S13, the control device 42 can utilize the internal steering system torque 30 indirectly in the course of the estimation of the actual driver torque, that is to say, of the torque that the driver applies to the steering wheel 24 for the purpose of steering specification. For this purpose, the control device 42 can, for example, correct the actual motor torque of the electric motor 34 of the steering-wheel actuator 32 at one point in time with the compensation torque ascertained in optional step S12. As a consequence, the control device 42 can ascertain or estimate the actual torque which is actually applied to the steering wheel 24 by the driver. Hence, the precision of further vehicle functionalities that exploit the ascertained or estimated driver torque in the respective control routines, for example a lane-keeping function, can be increased.

Moreover, the method 60 may feature optional step S14 in which the method 60 is repeated at predetermined time intervals and/or traveled distances and/or after corresponding fluctuations in temperature. Of course, the corresponding intervals and/or distances and/or fluctuations may result in regular repetitions. As a consequence, the characteristic of the rotation of the steering wheel 24 can also be kept constant over the service life of the steering wheel 24. In this way, variations, occurring for example over the service life, in the frictional processes of the steering-wheel bearing can be compensated, in order to ensure a uniform invariable steering feel for the driver of the motor vehicle 10.

In this regard, the method 60 enables the efficient and precise compensation of rotation-angle-dependent internal steering system torques 30 which otherwise influence the rotation of the steering wheel 24 and consequently degrade the steering feel for the driver of the motor vehicle 10. In addition, by virtue of the estimated internal steering system torque 30, an increased precision in the course of the torque feedback and/or the ascertainment of the actual driver torque applied to the steering wheel 24 by the driver of the motor vehicle 10 is made possible.

FIG. 4 shows a simplified schematic representation of a method 70 for the normal operating mode of the SBW steering system 14 according to a further embodiment.

The method 70 relates to the torque feedback for the driver, in order to make a feel concerning the lateral guidance of the motor vehicle 10 available to the driver of the motor vehicle 10 on the steering wheel 24.

In a conventional manner, signal values, for example rotational speeds of the vehicle wheels 16 and/or change-of-velocity values of the motor vehicle 10 corresponding to three directions oriented orthogonally to one another and/or a velocity of the vehicle, can firstly be captured and utilized, in order to characterize the driving situation of the motor vehicle 10, see step S15. From these values, the control device 42 can then ascertain, in accordance with step S16, the resulting effective lateral force acting on the motor vehicle 10. As a result, the control device 42 causes an actual value of a torque (non-disturbance-adjusted value) to be applied to the steering wheel 24 by the steering-wheel actuator 32 in order to convey to the driver of the motor vehicle 10 a feel concerning the lateral guidance of the motor vehicle 10.

According to the method 60, however, the angle of rotation captured during the predetermined rotation of the steering wheel 24 is now utilized in accordance with step S4. The control device 42 then implements the mass-inequality-distribution and friction-compensation algorithm 46. The mass-inequality-distribution and friction-compensation algorithm 46 is utilized at least in order to perform steps S2, S4 and S5 of the method 60. According to this embodiment, steps S9 and S12 are also performed in addition by the mass-inequality-distribution and friction-compensation algorithm 46. For this purpose, the mass-inequality-distribution and friction-compensation algorithm 46 may, for example, exploit a disturbance observer, an estimation algorithm or a torque-equilibrium equation in order to estimate the internal steering system torques 30. The control device 42 thereby ascertains a torque, estimated in accordance with the method 60, for the torque feedback on the steering wheel 24 (rotation-angle-dependent compensation torque as regards a torque to be applied).

As a consequence, according to the method 70, the control device 42 corrects the value of the torque ascertained from step S16 by the result of the mass-inequality-distribution and friction-compensation algorithm 46 in accordance with step S17. By way of example, a summation, an averaging or a normalization may be taken into account for this purpose. A corrected torque (disturbance-adjusted value) then results, which is to be applied to the steering wheel 24 of the SBW steering system 14 by the electric motor 34 of the steering-wheel actuator 32. In this way, the feedback on the steering wheel 24 for the driver of the motor vehicle 10 is made more precise in comparison with previous approaches, and, in particular, is compensated by the internal steering system torques 30.

FIG. 5 is a block diagram of an example programmable circuitry platform 500 structured to execute and/or instantiate the example machine-readable instructions and/or the example operations of FIGS. 3-4 to implement the control device 42 of FIG. 1. The programmable circuitry platform 500 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the control device 42.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the mass storage discs or devices 528 include the storage device 52.

The machine readable instructions 532, which may be implemented by the machine readable instructions of FIGS. 3-4, may be stored in the mass storage device 528, in the volatile memory 514, in the non-volatile memory 516, and/or on at least one non-transitory computer readable storage medium such as a CD or DVD which may be removable.

Specific embodiments disclosed herein make use of switching circuits (for example, one or more switching circuits) in order to implement standards, protocols, methods or technologies disclosed herein, to couple two or more components operationally, to generate information, to process information, to analyze information, to generate signals, to encode/decode signals, to convert signals, to transmit and/or receive signals, to control other appliances, etc. Use may be made of circuits of any type.

In one embodiment, a circuit, such as the control device 42, comprises, amongst other things, one or more data-processing devices such as a processor (for example, a microprocessor), a central processing unit (CPU), a digital signal processor (DSP), an application-specific integrated circuit (ASIC), a field-programmable gate array (FPGA), a system on a chip (SoC), or similar, or any combinations thereof, and may comprise discrete digital or analog circuit elements or electronics or combinations thereof. In one embodiment, the circuitry comprises hardware circuit implementations (for example, implementations in analog circuits, implementations in digital circuits, and such like, as well as combinations thereof).

In one embodiment, switching circuits comprise combinations of switching circuits and computer program products with software instructions or firmware instructions, which have been stored in one or more computer-readable memories and which work together in order to induce an appliance to execute one or more of the protocols, methods or technologies described herein. In one embodiment, the circuitry comprises switching circuits, such as, for example, microprocessors or parts of microprocessors, which require software, firmware and such like to operate. In one embodiment, the switching circuits comprise one or more processors or parts thereof and the associated software, firmware, hardware and such like.

In this disclosure, reference may be made to quantities and numbers. Unless specified expressly, such quantities and numbers are not to be regarded as limiting but are rather to be regarded as examples of the possible quantities or numbers in connection with the disclosure. In this context, the term "plurality" may also be used in this disclosure in order to refer to a quantity or number. The term "plurality" in this context means any number that is greater than one, for example two, three, four, five, etc. The terms "about", "approximately", "close to", etc., mean plus or minus 5 % of the specified value.

Example methods, apparatus, systems, and articles of manufacture to method and apparatus for operating a steer-by-wire steering system for a motor vehicle, subassembly and motor vehicle are disclosed herein. Further examples and combinations thereof include the following:

Example 1 includes a method for operating a steer-by-wire steering system for a motor vehicle in accordance with a calibration mode, the method comprising applying an actuating signal to a steering wheel actuator to rotate a steering wheel at a predetermined constant speed, capturing an angle of rotation of the steering wheel during the rotation of the steering wheel at the predetermined constant speed, and determining a rotation-angle-dependent motor torque of an electric motor of the steering wheel actuator that produced the rotation of the steering wheel at the predetermined constant speed.

Example 2 includes the method according to example 1, wherein determining the rotation-angle-dependent motor torque includes identifying includes identifying a captured torque in a steering column as a function of the angle of rotation, wherein the steering wheel is coupled with the steering column.

Example 3 includes the method of any one or more of examples 1-2, wherein determining the rotation-angle-dependent motor torque includes identifying a captured amplitude of an actuator current consumed by the steering wheel actuator.

Example 4 includes the method of any one or more of examples 1-3, wherein the actuating signal is a first actuating signal, the predetermined constant speed is a first predetermined constant speed, the angle of rotation is a first angle of rotation, and the rotation-angle-dependent motor torque is a first rotation-angle-dependent motor torque, further including applying a second actuating signal to the steering wheel actuator to rotate the steering wheel at a second predetermined constant speed, capturing a second angle of rotation of the steering wheel during the rotation of the steering wheel at the second predetermined constant speed, and determining a second rotation-angle-dependent motor torque of the electric motor of the steering wheel actuator that produced the rotation of the steering wheel at the second predetermined constant speed.

Example 5 includes the method of any one or more of examples 1-4, wherein the calibration mode of the steer-by-wire steering system is implemented during a manufacturing phase, an installation phase, a maintenance phase, a function-test phase, a starting-adjustment phase, an automatic maneuvering phase for pulling into or out of a parking space, an entry phase or exit phase, an absence phase, or a standstill phase of the motor vehicle.

Example 6 includes the method according to example 5, wherein the calibration mode of the steer-by-wire steering system is implemented repeatedly during corresponding phases of the motor vehicle at predetermined time intervals, at certain traveled distances, in function sequences, or depending on external conditions.

Example 7 includes the method of any one or more of examples 1-6, further including estimating an internal steering system torque acting on the rotation of the steering wheel associated with the captured angle of rotation based on the determined rotation-angle-dependent motor torque.

Example 8 includes the method according to example 7, wherein estimating the internal steering system torque includes utilizing a disturbance observer, an estimation algorithm, a Kalman filter, or a torque-equilibrium equation to estimate the internal steering system torque.

Example 9 includes the method of any one or more of examples 7-8, further including controlling a torque feedback provided by the steering wheel actuator to the steering wheel based on the estimated internal steering system torque, the torque feedback including a compensation torque that is based on and opposes the internal steering system torque.

Example 10 includes the method according to example 9, further including adjusting a motor torque of the electric motor of the steering wheel actuator with the compensation torque, and determining a driver torque applied to the steering wheel based on the motor torque.

Example 11 includes a subassembly for a vehicle comprising a steering wheel, a steering wheel actuator coupled with the steering wheel, the steering wheel actuator including a motor, a steering wheel sensor coupled with the steering wheel, and a control device coupled with the steering wheel actuator and with the steering wheel sensor, the control device to apply an actuating signal to the steering wheel actuator to rotate the steering wheel at a predetermined constant speed, identify an angle of rotation of the steering wheel during the rotation of the steering wheel at the predetermined constant speed, and determine a rotation-angle-dependent motor torque of the motor that produced the rotation of the steering wheel at the predetermined constant speed.

Example 12 includes the subassembly of example 11, wherein the control device is to at least one of (i) control a torque feedback that the steering wheel actuator provides to the steering wheel based on the rotation-angle-dependent motor torque, (ii) estimate a driver torque based on the rotation-angle-dependent motor torque, or (iii) determine whether a driver of the vehicle has hands on the steering wheel based on the rotation-angle-dependent motor torque.

Example 13 includes the apparatus of any one or more of examples 11-12, wherein, to determine the rotation-angle-dependent motor torque, the control device is to identify a captured torque in a steering column as a function of the angle of rotation, wherein the steering wheel is coupled with the steering column.

Example 14 includes the apparatus of any one or more of examples 11-13, wherein the actuating signal is a first actuating signal, the predetermined constant speed is a first predetermined constant speed, the angle of rotation is a first angle of rotation, and the rotation-angle-dependent motor torque is a first rotation-angle-dependent motor torque, wherein the control device is to apply a second actuating signal to the steering wheel actuator to rotate the steering wheel at a second predetermined constant speed, identify a second angle of rotation of the steering wheel during the rotation of the steering wheel at the second predetermined constant speed, and determine a second rotation-angle-dependent motor torque of the motor that produced the rotation of the steering wheel at the second predetermined constant speed.

Example 15 includes the apparatus of any one or more of examples 11-14, wherein the control device applies the actuating signal when operating in a calibration mode, the calibration mode to occur during a manufacturing phase, an installation phase, a maintenance phase, a function-test phase, a starting-adjustment phase, an automatic maneuvering phase for pulling into or out of a parking space, an entry phase or exit phase, an absence phase, or a standstill phase of the vehicle.

Example 16 includes the subassembly of example 15, wherein the calibration mode of the subassembly is implemented repeatedly during corresponding phases of the vehicle at least one of at predetermined time intervals, at certain traveled distances, in function sequences, or depending on external conditions.

Example 17 includes the apparatus of any one or more of examples 11-16, wherein the control device is to estimate an internal steering system torque acting on the rotation of the steering wheel associated with the identified angle of rotation based on the determined rotation-angle-dependent motor torque.

Example 18 includes the subassembly of example 17, wherein the control device is to control a torque feedback provided by the steering wheel actuator to the steering wheel based on the estimated internal steering system torque, the torque feedback including a compensation torque that is based on the internal steering system torque.

Example 19 includes a vehicle including a steering wheel, a steering wheel actuator coupled with the steering wheel, the steering wheel actuator including a motor, a steering wheel sensor coupled with the steering wheel, and a control device coupled with the steering wheel actuator and with the steering wheel sensor, the control device to apply an actuating signal to a steering wheel actuator to rotate a steering wheel at a predetermined constant speed, identify an angle of rotation of the steering wheel during the rotation of the steering wheel at the predetermined constant speed, and determine a torque of the motor that produced the rotation of the steering wheel at the predetermined constant speed, wherein the torque of the motor varies based on the angle of rotation.

Example 20 includes the vehicle of example 19, wherein the control device is to at least one of (i) control a torque feedback that the steering wheel actuator provides to the steering wheel based on the torque of the motor, (ii) estimate a driver torque based on the torque of the motor, or (iii) determine whether a driver of the vehicle has hands on the steering wheel based on the torque of the motor.

Although the disclosure has been presented and described with respect to one or more embodiments, after reading and understanding this description and the appended drawings, a person skilled in the art will be able to make equivalent alterations and modifications.

1. A method for operating a steer-by-wire steering system for a motor vehicle in accordance with a calibration mode, the method comprising:
applying an actuating signal to a steering wheel actuator to rotate a steering wheel at a predetermined constant speed;
capturing an angle of rotation of the steering wheel during the rotation of the steering wheel at the predetermined constant speed; and
determining a rotation-angle-dependent motor torque of an electric motor of the steering wheel actuator that produced the rotation of the steering wheel at the predetermined constant speed.

2. The method according to claim 1, wherein determining the rotation-angle-dependent motor torque includes identifying a captured torque in a steering column as a function of the angle of rotation, wherein the steering wheel is coupled with the steering column.

3. The method according to claim 1, wherein determining the rotation-angle-dependent motor torque includes identifying a captured amplitude of an actuator current consumed by the steering wheel actuator.

4. The method according to claim 1, wherein the actuating signal is a first actuating signal, the predetermined constant speed is a first predetermined constant speed, the angle of rotation is a first angle of rotation, and the rotation-angle-dependent motor torque is a first rotation-angle-dependent motor torque, further including:
applying a second actuating signal to the steering wheel actuator to rotate the steering wheel at a second predetermined constant speed;
capturing a second angle of rotation of the steering wheel during the rotation of the steering wheel at the second predetermined constant speed; and
determining a second rotation-angle-dependent motor torque of the electric motor of the steering wheel actuator that produced the rotation of the steering wheel at the second predetermined constant speed.

5. The method according to claim 1, wherein the calibration mode of the steer-by-wire steering system is implemented during a manufacturing phase, an installation phase, a maintenance phase, a function-test phase, a starting-adjustment phase, an automatic maneuvering phase for pulling into or out of a parking space, an entry phase or exit phase, an absence phase, or a standstill phase of the motor vehicle.

6. The method according to claim 5, wherein the calibration mode of the steer-by-wire steering system is implemented repeatedly during corresponding phases of the motor vehicle at predetermined time intervals, at certain traveled distances, in function sequences, or depending on external conditions.

7. The method according to claim 1, further including estimating an internal steering system torque acting on the rotation of the steering wheel associated with the captured angle of rotation based on the determined rotation-angle-dependent motor torque.

8. The method according to claim 7, wherein estimating the internal steering system torque includes utilizing a disturbance observer, an estimation algorithm, a Kalman filter, or a torque-equilibrium equation to estimate the internal steering system torque.

9. The method according to claim 7, further including controlling a torque feedback provided by the steering wheel actuator to the steering wheel based on the estimated internal steering system torque, the torque feedback including a compensation torque that is based on and opposes the internal steering system torque.

10. The method according to claim 9, further including:
adjusting a motor torque of the electric motor of the steering wheel actuator with the compensation torque; and
determining a driver torque applied to the steering wheel based on the motor torque.

11. A subassembly for a vehicle comprising:
a steering wheel;
a steering wheel actuator coupled with the steering wheel, the steering wheel actuator including a motor;
a steering wheel sensor coupled with the steering wheel; and
a control device coupled with the steering wheel actuator and with the steering wheel sensor, the control device to:
apply an actuating signal to the steering wheel actuator to rotate the steering wheel at a predetermined constant speed;
identify an angle of rotation of the steering wheel during the rotation of the steering wheel at the predetermined constant speed; and
determine a rotation-angle-dependent motor torque of the motor that produced the rotation of the steering wheel at the predetermined constant speed.

12. The subassembly of claim 11, wherein the control device is to at least one of (i) control a torque feedback that the steering wheel actuator provides to the steering wheel based on the rotation-angle-dependent motor torque, (ii) estimate a driver torque based on the rotation-angle-dependent motor torque, or (iii) determine whether a driver of the vehicle has hands on the steering wheel based on the rotation-angle-dependent motor torque.

13. The subassembly of claim 11, wherein, to determine the rotation-angle-dependent motor torque, the control device is to identify a captured torque in a steering column as a function of the angle of rotation, wherein the steering wheel is coupled with the steering column.

14. The subassembly of claim 11, wherein the actuating signal is a first actuating signal, the predetermined constant speed is a first predetermined constant speed, the angle of rotation is a first angle of rotation, and the rotation-angle-dependent motor torque is a first rotation-angle-dependent motor torque, wherein the control device is to:
apply a second actuating signal to the steering wheel actuator to rotate the steering wheel at a second predetermined constant speed;
identify a second angle of rotation of the steering wheel during the rotation of the steering wheel at the second predetermined constant speed; and
determine a second rotation-angle-dependent motor torque of the motor that produced the rotation of the steering wheel at the second predetermined constant speed.

15. The subassembly of claim 11, wherein the control device applies the actuating signal when operating in a calibration mode, the calibration mode to occur during a manufacturing phase, an installation phase, a maintenance phase, a function-test phase, a starting-adjustment phase, an automatic maneuvering phase for pulling into or out of a parking space, an entry phase or exit phase, an absence phase, or a standstill phase of the vehicle.

16. The subassembly of claim 15, wherein the calibration mode of the subassembly is implemented repeatedly during corresponding phases of the vehicle at least one of at predetermined time intervals, at certain traveled distances, in function sequences, or depending on external conditions.

17. The subassembly of claim 11, wherein the control device is to estimate an internal steering system torque acting on the rotation of the steering wheel associated with the identified angle of rotation based on the determined rotation-angle-dependent motor torque.

18. The subassembly of claim 17, wherein the control device is to control a torque feedback provided by the steering wheel actuator to the steering wheel based on the estimated internal steering system torque, the torque feedback including a compensation torque that is based on the internal steering system torque.

19. A vehicle comprising:
a steering wheel;
a steering wheel actuator coupled with the steering wheel, the steering wheel actuator including a motor;
a steering wheel sensor coupled with the steering wheel; and
a control device coupled with the steering wheel actuator and with the steering wheel sensor, the control device to:
apply an actuating signal to a steering wheel actuator to rotate a steering wheel at a predetermined constant speed;
identify an angle of rotation of the steering wheel during the rotation of the steering wheel at the predetermined constant speed; and
determine a torque of the motor that produced the rotation of the steering wheel at the predetermined constant speed, wherein the torque of the motor varies based on the angle of rotation.

20. The vehicle of claim 19, wherein the control device is to at least one of (i) control a torque feedback that the steering wheel actuator provides to the steering wheel based on the torque of the motor, (ii) estimate a driver torque based on the torque of the motor, or (iii) determine whether a driver of the vehicle has hands on the steering wheel based on the torque of the motor.
